(19) United States
(12) Patent Application Publication
(10) Pub. No.: US 2007/0069528 A1
(43) Pub. Date: Mar. 29, 2007

(54) Cable Seal With Re-Usable Body

(76) Inventor: Rainer Kuenzel, Hunt, TX (US)

Correspondence Address: TIM COOK, P.O. BOX 10107, LIBERTY, TX, 77575, US

(21) Appl. No.: 11/162,968

(22) Filed: Sep. 29, 2005

(51) Int. Cl. G09F 3/03

(52) U.S. Cl. 292/315

(57) ABSTRACT

A seal mechanism comprises a seal body and a cable or a bolt member extending through the seal body. The body of the mechanism remains attached to a host when the cable or bolt member is broken. In this way, the seal body, which comprises over half of the cost of the entire seal mechanism, is immediately available at the host for re-use.

### FIELD OF THE INVENTION

The present invention relates generally to the field of seals adapted to temporarily seal hasps and the like, including a cable or bolt member, and, more particularly, to a seal construction including a body which remains mechanically coupled to a door or other structure once the seal is broken. In this way, the body of the seal is used over and over again, resulting in substantial cost savings.

### BACKGROUND OF THE INVENTION

Door closures and locks are often provided with a seal mechanism to provide an indication that an intruder has attempted an unauthorized entry into the door or lock. Such a closure may comprise a hasp on a cargo door of a truck, for example, or other application. As used herein, the term “host” refers to the structure to which the door closure or lock applies.

The seal mechanism also typically includes a cable or a seal, which is inserted through a seal body. To break the seal, the cable or bolt is severed and withdrawn from the body. The severed cable or bolt is always discarded and the body of the seal mechanism is usually discarded even if it remains undamaged.

Thus, there remains a need for a seal including a seal body into which a new cable may be inserted and which body remains mechanically coupled to the host when the seal is broken. To prevent the re-usable body from being discarded, the body is permanently attached to the host.

### SUMMARY OF THE INVENTION

The present invention addresses these and other needs in the art by providing a seal body which remains attached to a host when the cable or bolt member is broken. In this way, the seal body, which comprises over half of the cost of the entire seal mechanism, is immediately available at the host for re-use.

In a preferred embodiment of the invention, the seal body is mechanically coupled to the host by way of a cable, strap, ring, or other mechanical means referred to generally in this description as an umbilical. The umbilical may be attached to the seal body through a hole in the body, by welding or brazing, or other easy and inexpensive coupling means. In another preferred embodiment, the seal body is attached to the host by way of a deformable flange. The deformable flange of this embodiment is initially made in the form of a tube or cylinder which is then inserted through a portion of a hasp. Once the cylinder of the deformable flange is inserted through one side of the hasp, a tool is inserted to bend the cylinder to a wider diameter, forming a firm and robust coupling between the seal body and the hasp.

The present invention includes a number of other features and advantages, including a button end of a seal cable which is positioned on a ledge on the outside of the seal body. Positioning the button end of the cable on the ledge maintains the alignment between the button end and the cable to prevent the cable from being broken prematurely or without authorization. The button end extends a distance beyond the top of the seal body to provide an amount of the button end to be available to be grasped by a grasping tool, such as a pair pliers.

The ledge arrangement also includes a pair of opposing rails, or other structure to guide the button end in alignment with the seal body. In another embodiment, two pairs of opposing rails are provided, or equivalent structure, so that the seal body can be used in either of two directions, thereby making the seal bidirectional.

These and other features of the present invention will be apparent to those skilled in the art from a review of the following detailed description along with the accompanying drawings.

### BRIEF DESCRIPTION OF THE DRAWINGS

So that the manner in which the above recited features, advantages, and objects of the present invention are attained and can be understood in detail, more particular description of the invention maybe had by reference to the embodiments thereof which are illustrated in the appended drawings. It is to be noted, however, that the appended drawings illustrate only typical embodiments of this invention and are therefore not to be considered limiting of its scope, for the invention may add to other equally effective embodiments.

FIG. 1 is a side section view of a prior art cable lock mechanism with a button end of the cable member within the body of the lock mechanism.

FIG. 2 is a side section view of a prior art cable lock mechanism with both ends of the cable member extending through the body of the lock mechanism.

FIG. 3 is a side section view of a lock mechanism of this invention showing the coupling feature of the invention.

FIG. 4 is a side view of a lock mechanism of the present invention.

FIG. 5 is a section view looking down into the mechanism along the section lines 5-5 of FIG. 3.

FIG. 6 is a side view of the lock mechanism of this invention showing the button end of the cable member and the free end of the cable member, both withdrawn from the lock body.

FIG. 7 is a side view of the lock mechanism of this invention mechanically attached to a hasp of a host.

FIG. 8 is a section view of the attaching mechanism of the lock mechanism of FIG. 7 before it is deformed to become of fixture of the hasp of the host.

FIG. 9 is a section view of the attaching mechanism after it has been deformed.

FIG. 10 is a section view of the lock mechanism with the attaching means of FIGS. 7 through 9 as applied to a re-usable bolt locking mechanism.

FIG. 11 is a section view of a bidirectional locking mechanism of the present invention.

FIG. 12 is a section view of the bidirectional locking mechanism of this invention showing a first direction of travel of the cable through the lock body.

FIG. 13 is a section view of the bidirectional locking mechanism of this invention showing a second direction of travel of the cable through the lock body.

### DETAILED DESCRIPTION OF A PREFERRED EMBODIMENT

FIG. 1 illustrates a known seal mechanism, designated generally with the numeral 10. This known mechanism comprises primarily a body 12 and a cable member 14. A button end 16 is attached to one end of the cable member 14 and the other end 18 of the cable is free. A cover 20 closes up the body 12 to retain the elements of the lock mechanism therein.

When the seal mechanism 10 is attached to a hasp or similar closure structure, the end 18 of the cable is positioned below the body 12 of the lock mechanism. The cable is then inserted through the hasp, and then into a hole 22 in the body. The cable is then fed into a chamber 24 where it is held against the side of the chamber by a roller 26. The roller 26 is biased by a spring 28. The cable end 18 then exits the body 12 through a hole 30 in the cover 20. Pulling the cable 14 further through the body serves to tighten the cable within the hasp. Further, if someone attempts to pull the cable out of the lock mechanism, the cable rides against the roller, pulling it down assisted by the biasing effect of the spring 28. The roller rides against a ramp 32, and thus the roller pinches off against the cable, stopping any further motion of the cable from the lock mechanism.

As used herein, the term “jam mechanism” refers to the friction mechanism just described, and other means by which the cable or bolt is permitted to freely move through the body in one direction, while precluding the free movement of the cable or bolt in the reverse direction, in a manner well known in the art.

This structure has proved very successful and become very popular. However, when an authorized person cuts the cable 14 at a loop 34 to remove the seal, the body 12 and all of the mechanism contained within it are typically discarded. This results primarily because the authorized person who removed the lock mechanism is left with a mechanism loose from the host to which it was attached. If somehow the mechanism were attached to the host and were structured in such a way as to be re-usable, it would be immediately available for locking the hasp for the next use of the host and a new cable could be installed. The present invention is directed to providing this need in the art.

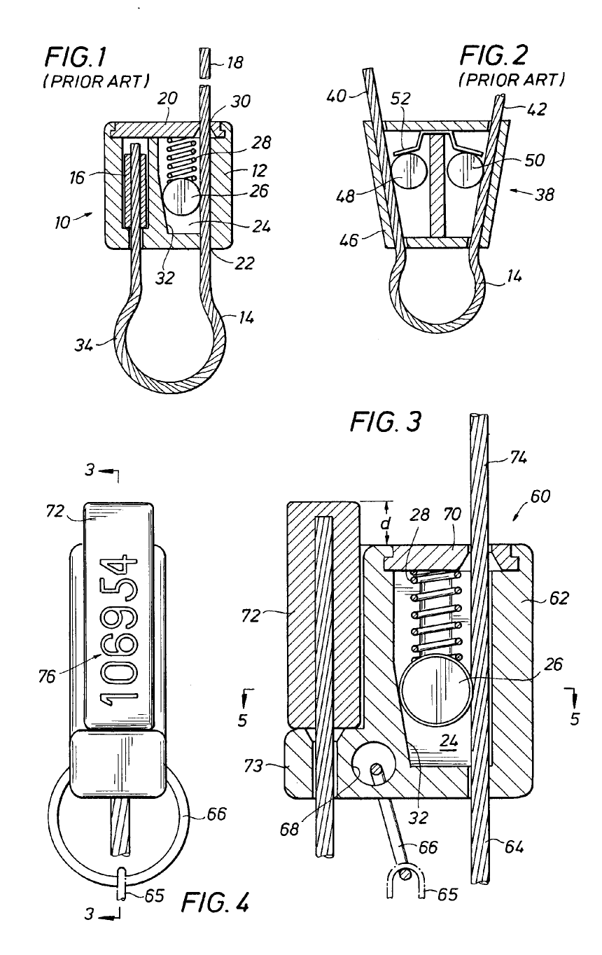

FIG. 2 illustrates another known seal mechanism 38 in which the cable 14 defines a first end 40 and a second end 42 both extend outside a body 44 of the lock mechanism 38. These ends are looped through the hasp, then the ends are inserted through a body 46 of the lock mechanism. A roller 48 rides against the end 40 of the cable and a roller 50 rides against the end 42. The rollers 48 and 50 are biased by a leaf spring 52. Once the ends are pulled to a desired length through the body, then any attempt to pull the lock mechanism off the hasp is prevented by friction action of the rollers against the cable. However, as previously described, when an authorized person cuts the cable to remove the seal, the body with the mechanism within it are typically thrown away.

FIGS. 3 through 6 depict a presently preferred embodiment of my solution to this recognized problem in the art. A seal mechanism 60 comprises a body 62 and a cable 64. Further, the body 62 is attached to a host 65 by an umbilical 66, illustrated in FIG. 3 by a chain link. The umbilical 66 joins to the body of the mechanism through a hole 68 in the body, for example, although many other means of joining the body to the host will be immediately apparent to those of skill in the art. For example the umbilical may comprise a strap or other flexible attaching means, and the umbilical may be welded or brazed to the body, or affixed to the body by other appropriate means.

The body 62 is enclosed by a cover 70 to define a chamber 24, like the chamber 24 of FIG. 1. Within the chamber 24 is a roller 26 biased by a coil spring 28 as previously described. As the cable 64 is pulled down, the roller rides against a ramp 32, pinching the cable as previously described thereby stopping further motion of the cable through the body. Those of skill in the art will be familiar with other jam mechanisms by which the cable is permitted to freely move through the mechanism in one direction, but is not permitted to freely move through the mechanism in the other direction.

The cable 64 defines a button end 72 and a free end 74 but in the embodiment illustrated in FIG. 3 the button end 72 is outside the body 62 and rests in abutting engagement with a ledge 73. This feature of the invention is important if the body and the mechanism within the body are to be used more than one time. In the embodiment illustrated in FIG. 1, once the cable is severed, the button end 1 6 remains within the body, and another cable cannot be inserted through the mechanism without removing the cover 20 and inserting a fresh cable and button end. This task is time consuming and labor intensive, and thus not cost effective.

The button end of the cable is preferably formed by crimping a relatively soft material, such as for example zinc or aluminum, onto the end of a relative hard material from which the cable is formed. The button end extends above the body and the cover by a distance d, adequate to allow grasping of the button end by a grasping tool, such as a pair of pliers.

FIG. 4 depicts another feature of this invention. The button end 72 may preferably include an identification number 76. In the past, an identification number has been etched or stamped onto the body of the locking mechanism to identify a cargo, load, or otherwise distinguish the host from others. However, if the body is to be re-used, then the same identification number must also be used, often resulting in confusion as to the identity of the cargo, load, or host. By forming the identification number on the button end, one is guaranteed that when the cable is severed and removed, the identification number is also discarded along with the cable.

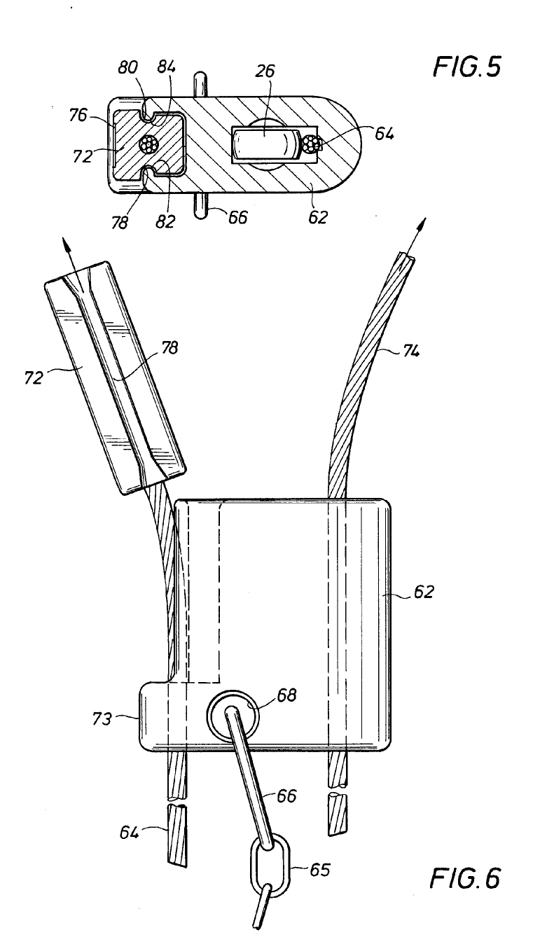

FIGS. 5 and 6 illustrate further features of the structure of this invention. FIG. 5 depicts a top down section view taken along section lines 5-5 of FIG. 3. The button end 72 defines a pair of opposing grooves 78 and 80 to slidingly mate with opposing rails 82 and 84, respectively. Alternatively, the button end may define a circular or similar cross section, so long as it is guided in relation to the body and to keep the cable intact. This feature retains the button end in proper orientation in relation to the body 62 and prevents the button end from being bent back and forth in an attempt to break the cable, while permitting visibility of the identification number and easy removal of the button end and consequently the cable. It should be noted that, in the preferred embodiment of FIG. 5, the button end is narrower in the portion engaged within the body than in the portion adjacent the ledge 73 so that the identification number 76 remains visible. For removal of the cable, the cable is cut or severed at some point below the body, as shown in FIG. 6, and the button end and the free end are pulled upward as seen in that drawing figure.

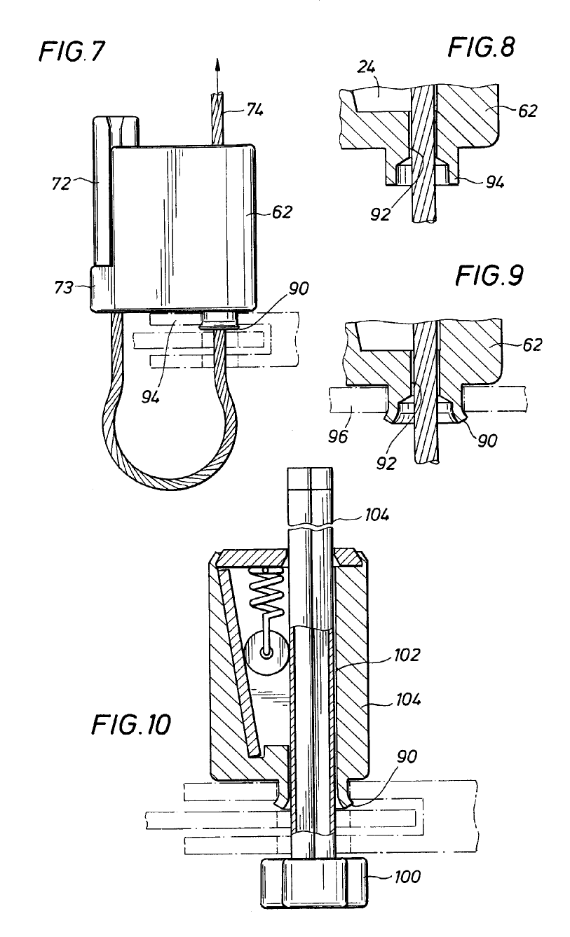

FIGS. 7 through 10 illustrate another preferred embodiment of the invention, wherein the body is affixed to host with a mounting flange member 90. As previously described, the button end 72 and the free end 74 extend from the body 62 of the seal mechanism. In this embodiment, however, the flange member 90 is integrally formed with the body 62. The flange member 90 defines a hole 92, which extends into the chamber 24 to guide the cable into the chamber. The hole widens out into a widened portion 94. As shown in FIGS. 8 and 9, the widened portion 94 is inserted into a hole in one side 96 of the female portion of a hasp. Then, the widened portion is deformed outward to form the mounting flange member 90, thereby attaching the seal mechanism to the host.

FIG. 10 illustrates the mounting flange member as applied to a re-usable bolt seal, as illustrated in U.S. Pat. No. 6,550,830, incorporated herein by reference. In this embodiment, the bolt seal mechanism defines an inner bolt member 100 and an outer sleeve member 102. By simultaneously cutting the bolt member 100 and the sleeve member 102, the bolt and sleeve can both be removed, but a body 104 and its attendant workings remain coupled to the side 96 of the hasp.

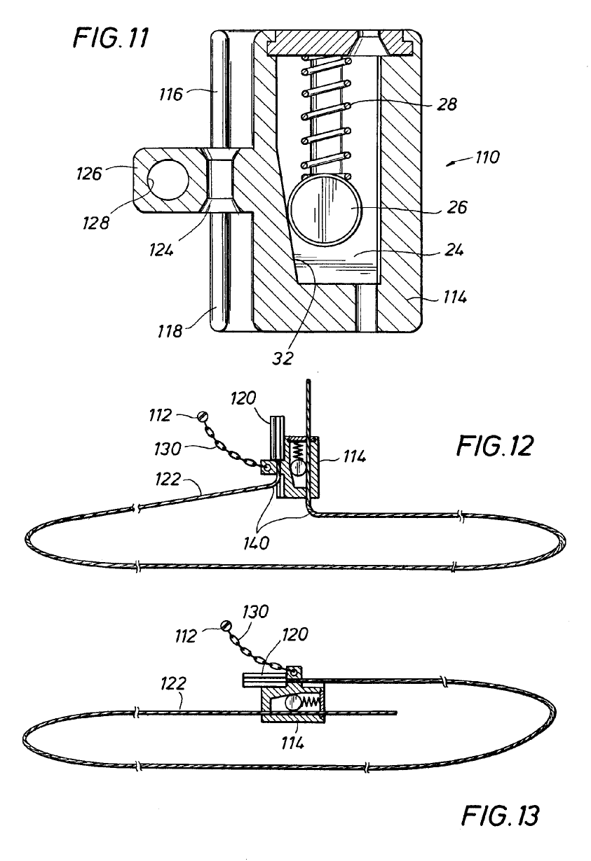

Finally, FIGS. 11 through 13 illustrate a bidirectional seal mechanism 110, which remains coupled to a host 112. The bidirectional seal mechanism 110 comprises a body 114 which defines a chamber 24 therein, which encloses the roller 26 biased by the spring 28. The roller rides against the ramp 32 to pinch a cable inserted through the chamber. In the embodiment of FIGS. 11 through 13, the body defines a first pair of rails 116 and a second pair of rails 118, each integrally formed with the body and adapted to receive a button end 120. A cable 122 extending from the button end 120 rides through a hole 124 in the body. A flange 126 with a hole 128 therein receives an umbilical 130, such as for example as chain or other connecting means, to attach the body 114 to the host 112.

In use, FIG. 12 shows the seal mechanism with the button end slidingly engaged with the rail 116 and FIG. 13 shows the button end slidingly engaged with the rail 18. In this way, the seal mechanism may be used with the cable extending in one direction from the body 114 (as in FIG. 12) or in opposite directions (as in FIG. 13). Usage as shown in FIG. 13 with cable 122 slung around a large diameter host would avoid a relatively sharp bends, such as a bend 140 in the cable as shown in FIG. 12.

The principles, preferred embodiment, and mode of operation of the present invention have been described in the foregoing specification. This invention is not to be construed as limited to the particular forms disclosed, since these are regarded as illustrative rather than restrictive. Moreover, variations and changes may be made by those skilled in the art without departing from the spirit of the invention.

In the claims:

1. A seal mechanism comprising:
a body defining a chamber therein;
a jam mechanism within the body;
a severable cable adapted to fit through the body; and
means for coupling the body to a host and for retaining the body coupled to the host when the cable is severed.

2. The seal mechanism of claim 1, wherein the cable defines a free end and a button end.

3. The seal mechanism of claim 2, further comprising
a pair of opposing grooves in the button end; and
a pair of opposing rails on the body outside the chamber adapted to slidingly mate with the grooves.

4. The seal mechanism of claim 1, further comprising an umbilical receiving hole in the body.

5. The seal mechanism of claim 4, wherein the means for coupling the body to a host comprises an umbilical coupled to the umbilical receiving hole.

6. The seal mechanism of claim 1, wherein the means for coupling the body to a host comprises a deformable flange member.

7. The seal mechanism of claim 2, further comprising a ledge outside the body adapted to receive the button end.

8. A seal mechanism comprising:
a body defining a chamber therein;
a jam mechanism within the body;
a severable bolt adapted to fit through the body; and
means for coupling the body to a host arranged for retaining the body coupled to a host when the bolt is severed.

9. The seal mechanism of claim 8, wherein the means for coupling the body to a host comprises a deformable flange member.

10. The seal mechanism of claim 9, wherein the host defines a hasp having a hole through at least a portion thereof, and further wherein the deformable flange member extends through the hole.

11. A seal mechanism comprising:
body defining a chamber therein;
a jam mechanism within the body;
a severable cable adapted to fit through the body, the cable defining a free end and a button end;
a first pair of opposing rails on the body outside the chamber and adapted to receive the button end of the cable;
a second pair of opposing rails on the body outside the chamber and adapted to receive the button end of the cable; and
means for coupling the body to a host and for retaining the body coupled to the host when the cable is severed.

12. The seal mechanism of claim 11, wherein the means for coupling the body to a host comprises an umbilical.

13. The seal mechanism of claim 11, wherein the means for coupling the body to a host comprises a deformable flange member.
